(19) United States
(12) Patent Application Publication
(10) Pub. No.: US 2026/0091674 A1
(43) Pub. Date: Apr. 2, 2026

(54) INFORMATION MANAGEMENT DEVICE, DISPLAY CONTROL METHOD AND PROGRAM

(71) Applicant: HONDA MOTOR CO., LTD., Tokyo (JP)

(72) Inventor: Junichiro Onaka, Tokyo (JP)

(21) Appl. No.: 19/310,980

(22) Filed: Aug. 27, 2025

(30) Foreign Application Priority Data
Sep. 30, 2024 (JP) 2024-170469

(51) Int. Cl. B60K 35/28; G06V 20/59; G06V 40/18; G06V 40/20

(52) U.S. Cl. CPC B60K 35/28; G06V 20/597; G06V 40/18; G06V 40/20; B60K 2360/176; B60K 2360/566

(57) ABSTRACT

An information management device manages information provided to a first device mounted on a mobile object and a second device used by a user at a different place from the mobile object. The information management device includes a display control part, a body movement information acquisition part, a detection part, and a detailed information acquisition part. The display control part causes the second device to display an image based on the image captured by an imaging part. The body movement information acquisition part acquires body movement information of the user. The detection part detects a feature in the image that the user focuses on based on the body movement information. The detailed information acquisition part acquires detailed information of the feature detected by the detection part. The display control part displays the feature and the detailed information in association with each other.

### CROSS-REFERENCE TO RELATED APPLICATION

Priority is claimed on Japanese Patent Application No. 2024-170469, filed Sep. 30, 2024, the content of which is incorporated herein by reference.

### BACKGROUND OF THE INVENTION

### Field of the Invention

The present invention relates to an information management device, a display control method and a program.

### Description of Related Art

Conventionally, studies have been made on communication between a device mounted on a mobile object such as a vehicle and a device used at a different place from the mobile object to share images of scenery outside the vehicle (for example, Patent Document 1 (Japanese Patent Application, Publication No. 2020-94958)). Also, it is known that an image of a real space is displayed on a head mounted display (HMD) and tourist information is displayed in correspondence with a building in the real space (for example, Patent Document 2 (Japanese Patent Publication No. 2018-97581)).

### SUMMARY OF THE INVENTION

However, the conventional technology has a problem that it is sometimes impossible to provide the user with information on a feature of interest to the user who is in a place different from the moving object.

The present invention was made in consideration of the aforementioned circumstances, and an objective thereof is to provide information on a feature of interest to the user.

An information management device, a display control method and a program according to the present invention employ the following configurations.

(1) An information management device according to one aspect of the present invention is the information management device that manages information provided to a first device mounted on a mobile object in or on which a passenger rides and a second device used by a user at a different place from the mobile object, the information management device comprising: a display control part configured to cause the second device to display an image based on a captured image captured by an imaging part provided by the first device; a body movement information acquisition part configured to acquire body movement information indicating a body movement of the user; a detection part configured to detect a feature in the image that the user focuses on based on the body movement information acquired by the body movement information acquisition part; and a detailed information acquisition part configured to acquire detailed information of the feature detected by the detection part; wherein the display control part displays the feature and the detailed information in association with each other.

(2) In the aspect of (1) described above, the body movement information may include gaze information indicating a gaze destination of the user, and the detection part may detect the feature at the gaze destination for a predetermined time or longer based on the gaze information.

(3) In the aspect of (1) or (2) described above, the body movement information may include behavior information indicating a behavior of the user, and the detection part may detect the feature indicated by the behavior based on the behavior information.

(4) In the aspect of (1) or (2) described above, the body movement information may include movement information includes audio information indicating a voice uttered by the user, and the detection part may detect the feature having a name uttered by the user based on the audio information.

(5) A display control method according to one aspect of the present invention is the display control method that is performed by a computer of an information management device that manages information provided to a first device mounted on a mobile object in or on which a passenger rides and a second device used by a user at a different place from the mobile object, the display control method comprising: a first display control step of causing the second device to display an image based on a captured image captured by an imaging part provided by the first device; a body movement information acquisition step of acquiring body movement information indicating a body movement of the user; a detection step of detecting a feature in the image that the user focuses on based on the body movement information acquired in the body movement information acquisition step; a detailed information acquisition step of acquiring detailed information of the feature detected in the detection step; and a second display control step of displaying the feature and the detailed information in association with each other.

(6) A program according to one aspect of the present invention is the program causing a computer of an information management device that manages information provided to a first device mounted on a mobile object in or on which a passenger rides and a second device used by a user at a different place from the mobile object, the computer to perform: causing the second device to display an image based on a captured image captured by an imaging part provided by the first device; acquiring body movement information indicating a body movement of the user; detecting a feature in the image that the user focuses on based on the body movement information acquired by a body movement information acquisition part; acquiring detailed information of the feature detected by a detection part; and displaying the feature and the detailed information in association with each other.

According to the aspects of (1) to (6), it is possible to provide the user with information on a feature of interest to the user.

### BRIEF DESCRIPTION OF THE DRAWINGS

FIG. 1 is a diagram showing an environment in which an information processing system and a management server are used.

FIG. 2A is a diagram showing an example of the content of user data.

FIG. 2B is a diagram showing an example of POI information stored in the provision information DB.

FIG. 3 is a diagram showing an example configuration of a first device.

FIG. 4 is a diagram showing an arrangement example of a part of the first device in a mobile vehicle M.

FIG. 5 is a diagram showing an example configuration of a second device.

FIG. 6 is a diagram showing an example of an angle of view corresponding to an oriented direction.

FIG. 7 is a diagram showing an example of a functional configuration of a first control device and a second control device.

FIG. 8 is a sequence diagram showing an example of processing executed by the information processing system.

FIG. 9 is a flowchart showing an example of a display processing of POI information performed by the management server.

FIG. 10 is a flowchart showing an example of a delete processing of POI information performed by the management server.

FIG. 11 is a diagram showing a display example of POI information based on gaze information.

FIG. 12 is a diagram showing a display example of POI information based on behavior information.

### DETAILED DESCRIPTION OF THE INVENTION

Hereinafter, an information management device, a display control method and a program according to an embodiment of the present invention will be described with reference to the accompanying drawings. In the following, an information processing system to which the information management device is applied will be described. The information processing system includes a first device, a second device and an information management device. The first device is mounted, for example, on a mobile object in/on which a passenger rides. The second device is used by a user at a different place from the mobile object. The information management device manages a first device and a second device. The mobile object is, for example, a vehicle. However, the mobile object may be any mobile object (for example, a ship or a flying object) as long as the mobile object can carry a passenger. The passenger is mainly a driver of the mobile object, but may be an occupant other than the driver.

Between the first device and the second device, the sounds collected by the microphone are transmitted to the other side and played by the speaker, as if a telephone conversation is performed. Furthermore, a part of the image captured by the camera unit of the first device is displayed on the second device, whereby MR (Mixed Reality) is provided to the second device. Thus, the user of the second device can obtain a feeling of being on the mobile object in a simulated manner (simulated riding experience) while being in a different place from the mobile object. Further, the passenger in/on the mobile object can have a conversation with the user through the first device, and thereby can obtain a feeling that the user is actually riding on the mobile object together. In the following description, the user's simulated experience as if he or she is actually riding the mobile object is referred to as “simulated riding”. In the information processing system, the first device and the second device do not need to be in a one-to-one relationship, but may be in a one to-many relationship. The first device may be provided more than one. Thus, in the information processing system, a plurality of second devices may be connected to each of the plurality of first devices. In this case, for example, one passenger can communicate with a plurality of users simultaneously or sequentially.

### Basic Configuration

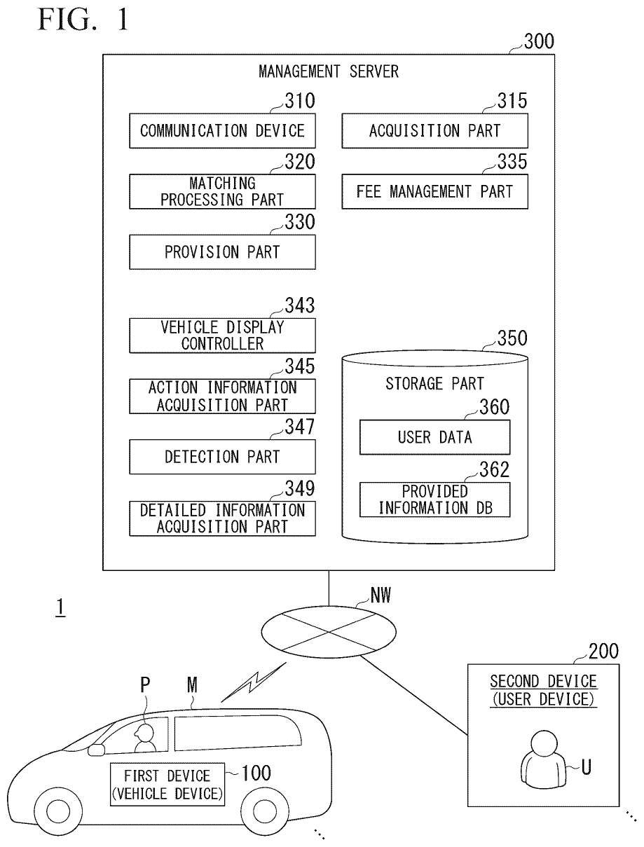

FIG. 1 is a diagram showing an environment in which an information processing system 1 and a management server 300 are used. The information processing system 1 includes a first device 100 and a second device 200. The first device 100 is a mobile device mounted on a mobile vehicle (a mobile object) M with a passenger P on board. The second device 200 is a user device used by a user U at a different place from the mobile vehicle M (it is not excluded that the user device happens to be close to the mobile vehicle M). The first device 100, the second device 200 and the management server 300 communicate with each other via a network NW. The network NW includes, for example, at least one of the following: the Internet, a Wide Area Network (WAN), a Local Area Network (LAN), a mobile communication network and a cellular network. The management server 300 is an example of an “information management device”. The management server 300 may be realized by a server device or storage device incorporated in a cloud computing system. In this case, the functions of the management server 300 may be realized by multiple server devices or storage devices in the cloud computing system. The first device 100 mounted on the mobile vehicle M may be realized by a plurality of units.

The management server 300 manages information provided to each of the first device 100 and the second device 200, and manages communication between each of the first device 100 and the second device 200. As shown in FIG. 1, the management server 300 includes, for example, a communication device 310, a matching processing part 320, a provision part 330, a fee management part 335, a vehicle display controller 343, an action information acquisition part (body movement information acquisition part in claims) 345, a detection part 347, a detailed information acquisition part 349 and a storage part 350. The matching processing part 320, the provision part 330, the fee management part 335, the vehicle display controller 343, the action information acquisition part 345, the detection part 347 and the detailed information acquisition part 349 are realized, for example, by causing a hardware processor such as a central processing unit (CPU) to execute a program (software). Some or all of these constituents may be realized by hardware (including circuitry) such as a large scale integration (LSI) circuit, an application-specific integrated circuit (ASIC), a field-programmable gate array (FPGA), a graphics processing unit (GPU) or may be cooperatively realized by software and hardware. The program may be stored in a storage device (a storage device including a non-transitory storage medium) such as a hard disk drive (HDD) or a flash memory in advance or may be stored in a detachable storage medium (a non-transitory storage medium) such as a DVD or a CD-ROM and installed by setting the storage medium into a drive device. The program may be stored in the management server 300 and updated as appropriate by connecting to the network NW.

The communication device 310 is a communication interface for connecting to the network NW. Communication between the communication device 310 and the first device 100 and communication between the communication device 310 and the second device 200 are performed in accordance with, for example, TCP/IP (Transmission Control Protocol/Internet Protocol).

The matching processing part 320 is realized, for example, by a processor such as a CPU executing a program (a group of instructions) stored in a storage medium. For example, when the communication device 310 receives a matching request from the user U via the second device 200 or from the passenger P via the first device 100, the matching processing part 320 performs matching between the user U and the passenger P by referring to the user data 360, transmits the communication identification information of the first device 100 of the passenger P to the matched second device 200 of the user U by using the communication device 310, and transmits the communication identification information of the second device 200 of the user U to the matched first device 100 of the passenger P. Between the first device 100 and the second device 200 that have received the data, it is possible to execute communication with a higher real-time performance, for example, in conformity with the UDP (User Datagram Protocol).

The provision part 330 generates information to be provided to each of the first device 100 and the second device 200, and transmits the generated information to the target device. The provision part 330 generates information indicating the processing result by the matching processing part 320 and/or fee information (settlement information) managed by the fee management part 335, and provides the generated information to the target device.

The fee management part 335 manages the fees charged to the user U according to the information provided to the user U and/or the fees charged to the passenger P according to the information provided to the passenger P of the mobile vehicle M. The fee management part 335 may manage, for example, the amount of fees to be paid to the user U or the passenger P in accordance with the information provided by the user U or the passenger P. The fee management part 335 may perform processing relating to the settlement of the user U and the passenger P.

The storage part 350 may be realized by the aforementioned various storage devices, a solid-state drive (SSD), an electrically erasable programmable read only memory (EEPROM), a read only memory (ROM), a random-access memory (RAM), or the like. The storage part 350 stores, for example, user data 360, a provided information DB362, a program, and other various information. The user data 360 and the provided information DB362 are not limited to being provided in the management server 300, and may be provided in other devices. In this case, the management server 300 may access the other devices and acquire the user data 360 and the provided information DB362 from the other devices.

The vehicle display controller 343, the action information acquisition part 345, the detection part 347 and the detailed information acquisition part 349 will be described later.

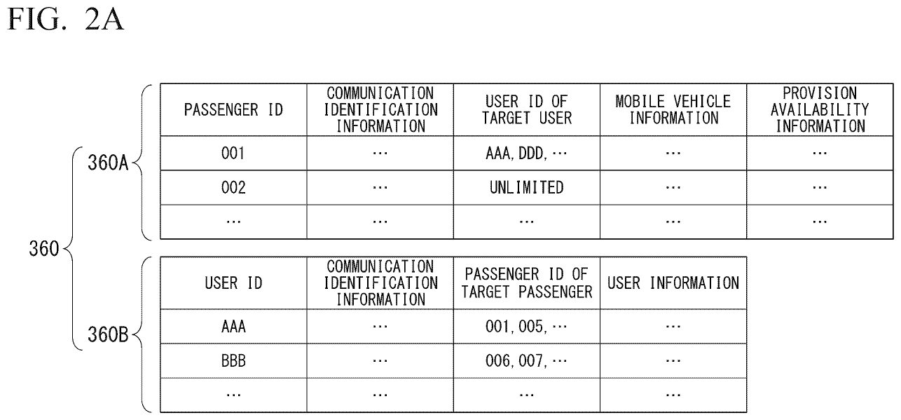

FIG. 2A is a diagram showing an example of the content of user data 360. The user data 360 includes a passenger list 360A and a user list 360B. The passenger list 360A includes, for example, a passenger ID, communication identification information, a user ID of the target user U, mobile vehicle information and provision availability information. The passenger ID is identification information of the passenger P of the mobile vehicle M. The communication identification information is information for identifying the first device 100, such as an IP address. The user ID is identification information of the user U to be matched. The mobile vehicle information includes, for example, equipment information (onboard equipment information) mounted on the mobile vehicle M and vehicle class information indicating the size and outer shape of the mobile vehicle M. The mobile vehicle information may include information on the current position and destination of the mobile vehicle M and the surrounding situation (e.g., traveling on a road along the sea) transmitted from the mobile vehicle M at a predetermined cycle.

The provision availability information indicates various information that can be (or cannot be) provided to the user U. The provision availability information is set by the passenger P. The provision availability information may be set for each onboard equipment of the mobile vehicle M or for each user U. The provision availability information includes, for example, “image provision is permitted / not permitted”, “audio provision is permitted / not permitted”, “indoor image provision is permitted / not permitted”, “outdoor image provision is permitted / not permitted”, “passenger image provision is permitted / not permitted”, “use of the navigation device is permitted / not permitted”, and the like. The provision availability information may include a fee (service provision fee) for enabling the provision.

The user list 360B includes, for example, a user ID, communication identification information (IP address or the like), a passenger ID of the passenger P to be matched, and user information. The user ID is identification information of the user U. The communication identification information is information for identifying the second device 200, such as an IP address. The passenger ID is identification information of the passenger P to be matched. The user information is information relating to the user U, and may include, for example, information relating to the physique (e.g., height and sitting height), information for predicting the physique (e.g., age), and the like. The user data 360 is not limited to the aspect shown in FIG. 2A and may be generated in any aspect as long as it includes this information.

The provision information DB 362 stores various kinds of information to be provided to the user U or the passenger P. The various kinds of information include, for example, map information, Point Of Interest (POI) information, and images drawn by computer processing (for example, Computer Graphics (CG) images of persons and images such as marks, symbols, icons, and the like). The POI information is information relating to various stores, theme parks, or features for each point, and may be included in the map information. The various kinds of information may include audio information.

FIG. 2B is a diagram showing an example of POI information stored in the provision information DB 362. The POI information (an example of detailed information) includes items such as position information, feature name, evaluation, online reviews, and basic information. The position information is information indicating the location of the feature on the map information. The feature name indicates the name of the feature. Features include everything included on the map, such as stores, facilities, buildings, structures, relics, mountains, rivers, seas, and sightseeing spots.

The evaluation is a score calculated based on the evaluation of each user who uses the feature of the target. The online reviews are comments of users who used or went to the feature. The basic information includes information such as an address, contact details, and opening hours of the feature. In the case of a building, for example, the basic information can include all information relating to the building (for example, the age of the building, the floor, the construction company, the management company, the usage fee, and the like).

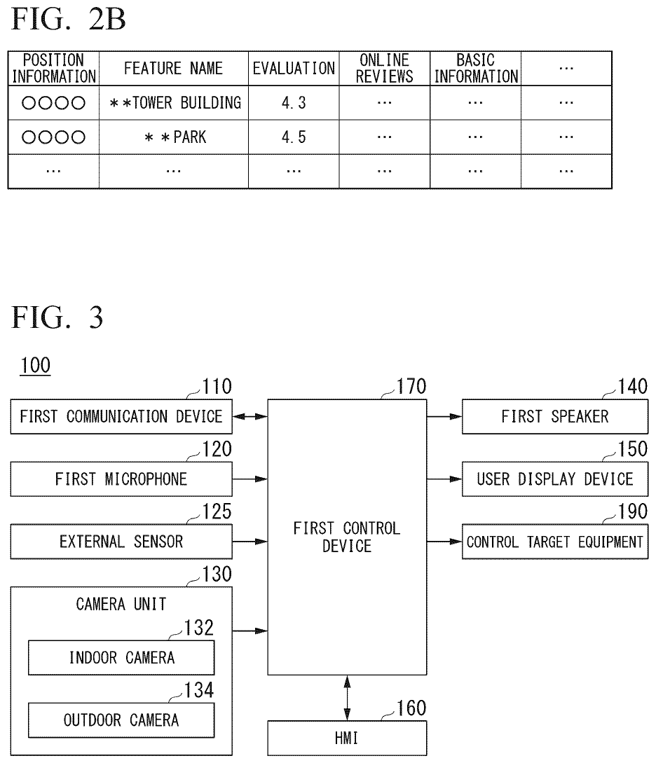

FIG. 3 is a diagram showing an example configuration of a first device 100. The first device 100 includes, for example, a first communication device 110, a first microphone 120, an external sensor 125, a camera unit 130, a first speaker 140, a user display device 150, a Human Machine Interface (HMI) 160, and a first control device 170. The first control device 170 is connected to a control target equipment 190 mounted on the mobile vehicle M.

The first communication device 110 is a communication interface for communicating with the communication device 310 of the management server 300 and the second communication device 210 of the second device 200 via the network NW.

The first microphone 120 is provided inside or outside the mobile vehicle M, and can collect the voice emitted by the passenger P and the audio outside the mobile vehicle M. Hereinafter, the audio information acquired by the microphone provided inside the mobile vehicle M may be referred to as “indoor audio information”. The voice collected by the first microphone 120 is transmitted, for example, to the management server 300 or the second device 200 by the first communication device 110 via the first control device 170. In the case where the mobile vehicle M is configured not to include a microphone provided outside the mobile vehicle M, the indoor audio information may be processed based on the traveling information (speed, acceleration/deceleration, road surface vibration, etc.) and the surrounding traveling environment to generate the simulated outdoor audio information. Further, the positional relationship of the person speaking (the speaker) with respect to the mobile vehicle M (for example, whether the speaker is inside or outside the vehicle) can be recorded, and the collected voice may be processed according to the positional relationship.

The external sensor 125 detects the position of an object around the mobile vehicle M. The external sensor 125 is, for example, a radar device, a Light Detection and Ranging (LIDAR) sensor, or other various proximity sensors. The radar device emits a radio wave such as a millimeter wave to the periphery of the mobile vehicle M and detects a radio wave (reflected wave) reflected by the object to detect at least the position (distance and direction) of the object. The radar apparatus may detect the position and velocity of the object by a Frequency Modulated Continuous Wave (FM-CW) system.

The LIDAR sensor irradiates light (or an electromagnetic wave having a wavelength close to light) to the periphery of the mobile vehicle M, measures the scattered light, and detects the distance to the object based on the time from light emission to light reception. The light to be irradiated is, for example, a pulsed laser light. The radar device and the LIDAR sensor are attached to an arbitrary position of the mobile vehicle M. The external sensor 125 may detect the surrounding object using the image captured by the outdoor camera 134 of the camera unit 130.

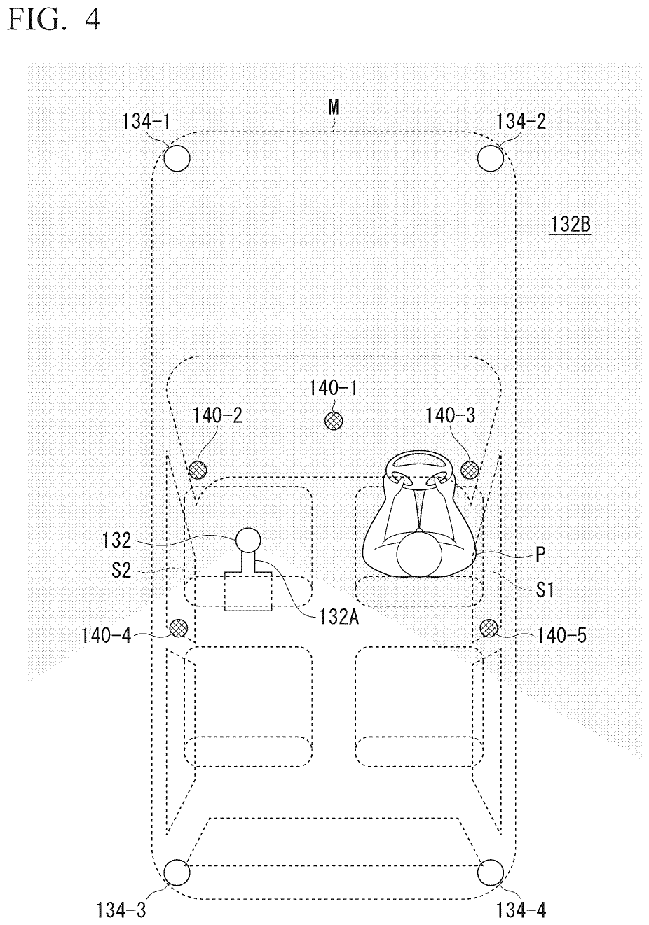

The camera unit 130 includes, for example, an indoor camera 132 and an outdoor camera 134. The first speaker 140 outputs the sound uttered by the user U and acquired via the first communication device 110. The arrangement of the camera unit 130 and the first speaker 140 will be described in detail later with reference to FIG. 4.

The user display device 150 displays the user U virtually as if the user U were present inside of the mobile vehicle M. For example, the user display device 150 causes a hologram to appear and also displays the user U in a part corresponding to a mirror or window of the mobile vehicle M.

The HMI 160 is a touch panel, an audio response device (agent device), or the like. The HMI 160 receives various instructions from the passenger P to the first device 100 and provides the passenger P with various information.

The first control device 170 includes, for example, a processor such as a CPU and a storage medium connected to the processor and storing a program (instruction group), and controls each part of the first device 100 by the processor executing the instruction group.

The control target equipment 190 is, for example, an in-vehicle equipment mounted on the mobile vehicle M such as a navigation device for guiding a route to a destination or a driving assistance device for controlling one or both of steering and speed of the mobile vehicle M to assist driving of the passenger P. The control target equipment 190 includes a seat drive device capable of adjusting, for example, the position (front, rear, left, right), orientation, and height of a seat. When the camera unit 130 of the first device 100 is attached to the seat and the second device 200 is used to view an image, the movement of the seat is prohibited, thereby suppressing the influence on the image. Even when the seat is allowed to move, processing such as angle-of-view conversion may be performed so as not to affect the image by the movement of the seat. When the user U requests to view an image outside the field angle of the current camera unit 130, the seat drive device may be controlled as a request from the second device 200.

FIG. 4 is a diagram showing an arrangement example of a part of the first device 100 in a mobile vehicle M. The indoor camera 132 is attached, for example, to a neck pillow of the passenger seat S2 (an example of a “predetermined seat”) via an attachment 132A and is provided at a position slightly deviated from the backrest of the passenger seat S2 toward the traveling direction of the mobile vehicle M. The indoor camera 132 has a wide-angle lens and can take images of a range represented by a hatched area 132B in the figure. The indoor camera 132 can take images not only inside the mobile vehicle M but also outside the mobile vehicle M through a window. In the following description, the passenger seat S2 is assumed to be a predetermined seat, but the predetermined seat may be another seat such as a rear seat or the like.

The outdoor camera 134 includes, for example, a plurality of sub-outdoor cameras 134-1 to 134-4. By synthesizing the images captured by the plurality of sub-outdoor cameras 134-1 to 134-4, an image such as a panoramic image of the outside of the mobile vehicle M is obtained. Alternatively (or additionally), the outdoor camera 134 may include a wide-angle camera provided on the roof of the mobile vehicle M. A camera capable of capturing an image of the rear of the passenger seat S2 may be added as the indoor camera 132. The image captured by the camera unit 130 may be generated as a 360-degree panoramic image. The 360-degree panoramic image may be generated, for example, by combining images captured by one or more indoor cameras 132 by the first control device 170, or by combining images captured by the indoor camera 132 and images captured by the outdoor camera 134.

The first speaker 140 outputs the voice of the user U. The voice is acquired through the first communication device 110. The first speaker 140 includes, for example, a plurality of sub-first speakers 140-1 to 140-5. For example, the sub-first speakers 140-1 is disposed in the center of the instrument panel. The sub-first speakers 140-2 is disposed at the left end of the instrument panel. The sub-first speakers 140-3 is disposed at the right end of the instrument panel. The sub-first speakers 140-4 is disposed in the lower portion of the left door. The sub-first speakers 140-5 is disposed in the lower portion of the right door.

When the first control device 170 causes the first speaker 140 to output the voice of the user U, the first control device 170 localizes the sound image against the passenger P seated in the driver's seat S1 so that the voice can be heard from the passenger seat S2. The sound image localization is, for example, to output the sound from the sub-first speakers 140-2 and 140-4 at the same volume and to turn off the other sub-first speakers. Note that the sound image localization is not limited to be performed by adjusting the volume, and may be performed by shifting the phase (timing) of the sound output from each of the sub-first speakers 140. For example, in the case of localizing a sound image so that the sound can be heard from the left side, the timing of outputting the sound from the left sub-first speaker may be set slightly earlier than the timing of outputting the same sound from the right sub-first speaker.

In addition, when the first control device 170 causes the first speaker 140 to output the voice of the user U, the first control device 170 may cause the first speaker 140 to output the voice uttered by the user U by localizing the sound image so that the passenger P can hear the voice from a position corresponding to the height of the head of the user U on the passenger seat S2. In this case, the first speaker 140 needs to have a plurality of sub-first speakers 140-k (k is a plurality of natural numbers) located at different height positions.

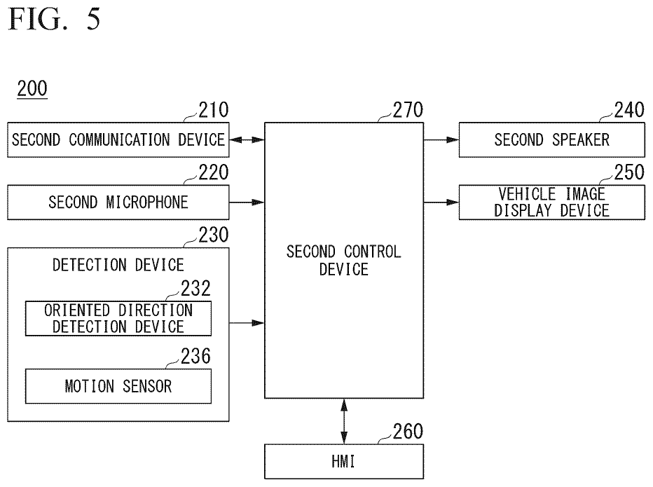

FIG. 5 is a diagram showing an example configuration of a second device 200. The second device 200 includes, for example, a second communication device 210, a second microphone 220, a detection device 230, a second speaker 240, a vehicle image display device 250, an HMI 260 and a second control device 270. The detection device 230 includes an oriented direction detection device 232 and a motion sensor 236.

The second communication device 210 is a communication interface for communicating with the communication device 310 of the management server 300 and the first communication device 110 of the first device 100 via the network NW.

The second microphone 220 collects the voice uttered by the user U. The sounds collected by the second microphone 220 is transmitted to the management server 300 and the first communication device 110 by the second communication device 210 via the second control device 270, for example.

The oriented direction detection device 232 is a device for detecting an oriented direction. The oriented direction is a direction based on the direction of the face of the user U, the direction of the gaze, or both of them. The oriented direction is an angle including a component of the vertical direction. However, the oriented direction may be an angle in a horizontal plane. That is, the oriented direction may not include a component of the vertical direction. The oriented direction detection device 232 may include a physical sensor (e.g., an acceleration sensor, a gyro sensor, and so on) attached to a VR goggles, which will be described later. The oriented direction detection device 232 may include an infrared sensor for detecting a plurality of positions of the head of the user U or a camera for capturing an image of the head of the user U. In either case, the second control device 270 calculates the oriented direction based on the information input from the oriented direction detection device 232. Since various techniques are known, a detailed description thereof will be omitted. The information indicating the oriented direction detected by the oriented direction detection device 232 is transmitted to the management server 300 by the second communication device 210.

The motion sensor 236 is a device for recognizing a gesture operation performed by the user U. For example, a camera for capturing an image of the upper body of the user U is used as the motion sensor 236. In this case, the second control device 270 extracts characteristic points (fingertips, wrists, elbows, and so on) of the body of the user U from the image captured by the camera, and recognizes the gesture operation of the user U based on the movement of the characteristic points. Information indicating the gesture operation recognized by the motion sensor 236 is transmitted to the management server 300 by the second communication device 210.

The second speaker 240 outputs various sounds. For example, the second speaker 240 outputs the sound uttered by the passenger P. The sound is acquired via the second communication device 210. The second speaker 240 has a function, for example, to change the direction in which the sound is heard. The second control device 270 causes the second speaker 240 to output the sound so that the user U can hear the sound from the position of the passenger P as seen from the passenger seat S2. The second speaker 240 includes a plurality of sub-second speakers 240-n (n is a plurality of natural numbers). The second speakers 240 perform sound image localization by the second control device 270 adjusting the volume of each sub-second speaker 240-n. If a headphone is attached to the VR goggles, the sound image localization may be performed by using the function of the headphone.

The vehicle image display device 250 displays an image corresponding to the oriented direction viewed from the passenger seat S2 among images (images subjected to the combination processing may be used, and hereinafter referred to as a vehicle image) captured by the camera unit 130.

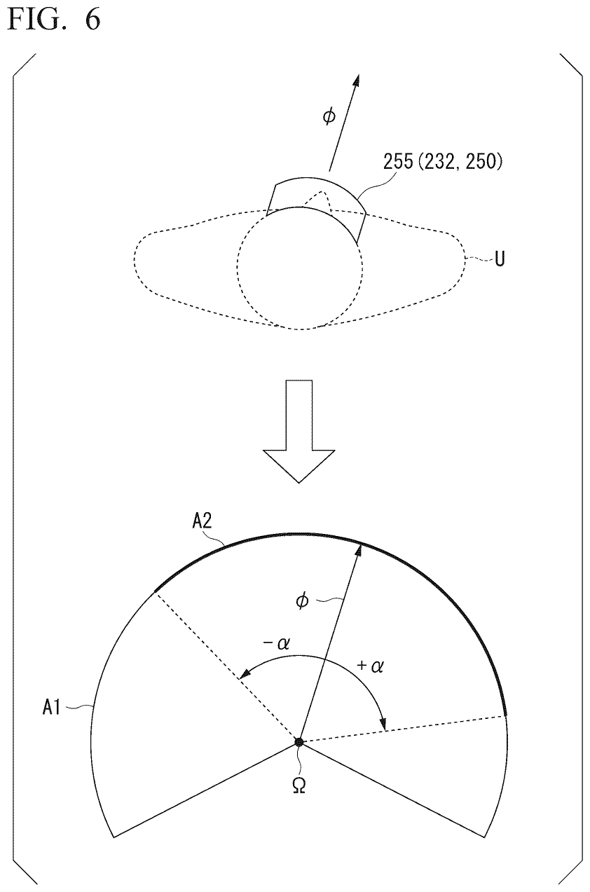

FIG. 6 is a diagram showing an example of an angle of view corresponding to an oriented direction. In the example of FIG. 6, the VR goggles 255 includes a physical sensor as the oriented direction detection device 232 and the vehicle image display device 250. The second control device 270 sets, for example, the center of the head of the user U or the center of the VR goggles 255 as Ω, and detects a direction in which the VR goggles 255 is pointing, with reference to a pre-calibrated reference direction, as the pointing direction φ. Since various methods for such functions are already known, detailed description thereof will be omitted.

The vehicle image display device 250 displays the visual image A2 within an angular range of plus/minus α centered on the oriented direction φ among the vehicle image A1 (having an angle of about 240 degrees in the figure, but the angle of view may be expanded by the combination processing) toward the user U. Although the example of FIG. 6 shows the oriented direction φ for the movement of the head of the user U in the left and right directions, it is also possible to perform a process of cutting out an image corresponding to the oriented direction for the movement of the head in the vertical directions.

The HMI 260 is a touch panel, an audio response unit (agent device), a switch, or the like. The HMI 260 receives various instructions from the passenger P to the second device 200.

The second control device 270 includes, for example, a processor such as a CPU and a storage medium connected to the processor and storing a program (instruction group), and controls each part of the second device 200 by the processor executing the instruction group. The second device 200 may be configured such that all the functions shown in FIG. 5 are integrated into a VR goggle unit.

### Functional Configurations of First Control Device 170 and Second Control Device 270

The functional configurations of the first control device 170 and the second control device 270 will be described below. In the following example, it is assumed that provided information is mainly generated and transmitted between the first control device 170 and the second control device 270, and the management server 300 manages the matching for simulated riding between the passenger P and the user U.

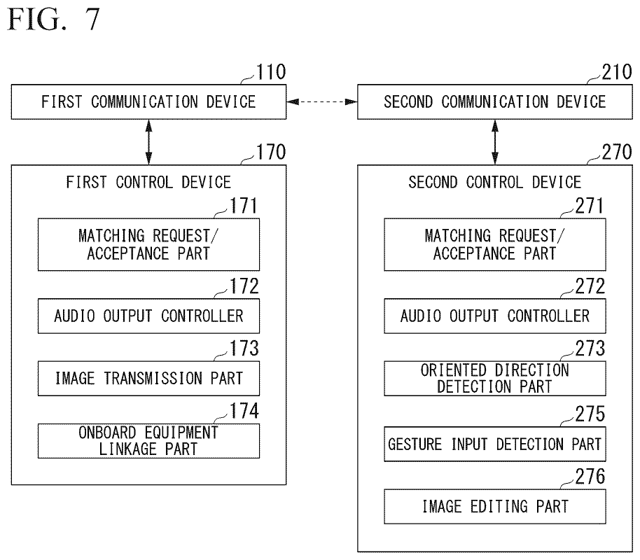

FIG. 7 is a diagram showing an example of a functional configuration of a first control device 170 and a second control device 270. In FIG. 7, the first control device 170 includes a matching request/acceptance part 171, an audio output controller 172, an image transmission part 173, and an onboard equipment linkage part 174. The second control device 270 includes a matching request/acceptance part 271, an audio output controller 272, an oriented direction detection part 273, a gesture input detection part 275, and an image editing part 276. These functional parts are realized by, for example, a processor such as a CPU executing a program (instruction group). Some or all of these components may be realized by hardware (including circuitry) such as an LSI, an ASIC, an FPGA, or a GPU, or may be realized by a combination of software and hardware.

The matching request/acceptance part 171 accepts input of a matching request (simulated riding request) from the passenger P using the HMI 160 and transmits the matching request to the management server 300, and accepts input of acceptance against the matching request received from the management server 300 using the HMI 160 and transmits the acceptance to the management server 300. The matching request/acceptance part 171 controls the first communication device 110 so that the second device 200 of the user U, which has been matched, becomes a communication partner. The matching request/acceptance part 171 may accept, for example, the setting of provision availability information indicating what information is permitted to be provided from the passenger P when accepting the matching request obtained from the management server 300.

The audio output controller 172 controls the first speaker 140.

After the communication with the second device 200 is started, the image transmission part 173 transmits the vehicle image A1 to the second device 200 by using the first communication device 110. The vehicle image A1 may include, for example, an indoor image captured by the indoor camera 132 and/or an outdoor image captured by the outdoor camera 134.

The onboard equipment linkage part 174 controls the control target equipment 190 based on the instruction signal input from the second device 200. The onboard equipment linkage part 174 may perform the control when the passenger P permits the user U to control the control target equipment 190.

The matching request/acceptance part 271 accepts input of a matching request (simulated riding request) from the user U using the HMI 260 and transmits the matching request to the management server 300, and accepts input of acceptance against the matching request received from the management server 300 using the HMI 260 and transmits the acceptance to the management server 300. The matching request/acceptance part 271 controls the second communication device 210 so that the first device 100 of the passenger P, which has been matched, becomes a communication partner. The matching request/acceptance part 271 may present to the user U and allow the user U to confirm what information is provided based on the matching result (request result) obtained from the management server 300, and then accept an instruction from the user U as to whether or not to perform the simulated riding.

The audio output controller 272 controls the second speaker 240.

The oriented direction detection part 273 detects the oriented direction φ based on the output of the oriented direction detection device 232. The gesture input detection part 275 detects a gesture input of the user U based on an output of the motion sensor 236.

The image editing part 276 performs a process of cutting out, for example, the visual image A2 corresponding to the oriented direction φ viewed from the passenger seat S2 from the vehicle image A1 (FIG. 6). The visual image A2 cut out by the image editing part 276 is sequentially transmitted to the management server 300 by the second communication device 210.

### Configuration of Vehicle Display Controller 343 and Other Components of Management Server 300

Next, the vehicle display controller 343, the action information acquisition part 345, the detection part 347, and the detailed information acquisition part 349 of the management server 300 shown in FIG. 1 will be described. Although the details will be described later, these functional parts may be provided in the second device 200.

### vehicle Display Controller 343

The vehicle display controller 343 (an example of a display control part) controls an image to be displayed on the second device 200. The vehicle display controller 343 causes the second device 200 to display the visual image A2 based on the image captured by the camera unit 130 (an example of an imaging part) included in the first device 100. Specifically, the vehicle display controller 343 causes the vehicle image display device 250 to display the visual image A2 cut out by the image editing part 276. The visual image A2 may be an image corresponding to the oriented direction φ viewed from the height indicated by the height information of the head of the user U. For example, the visual image A2 may be an indoor image or an outdoor image which can be switched according to the distance (for example, the amount of movement of the head in the vertical direction or in the lateral direction) from the reference position of the head of the user U.

### Action Information Acquisition Part 345

The action information acquisition part 345 acquires action information (body movement information in claim) of the user U transmitted by the second device 200 via the network NW. The action information includes gaze information, behavior information and audio information. The gaze information is information indicating the direction of the gaze (line of sight) detected by the oriented direction detection device 232. The behavior information is information indicating the behavior of the user U. The behavior information includes information indicating a fingertip recognized by the motion sensor 236 and information indicating a direction of a face detected by the oriented direction detection device 232. The audio information is collected by the second microphone 220.

### Detecting Part 347

The detection part 347 detects a feature (hereinafter referred to as “gazed feature” (feature in the image that the user focuses on)) to which the user U gazes in the visual image A2 based on the action information acquired by the action information acquisition part 345. Specifically, the detection part 347 detects a feature to which the line of sight is directed for a predetermined time (for example, 3 seconds) or longer as a gazed feature based on the gaze information. The detecting part 347 detects a feature at a point (a direction of a fingertip or a face) indicated by the behavior as the gazed feature based on the behavior information. Furthermore, the detection part 347 detects a feature having a name uttered by the user U as the gazed feature based on the audio information. The detection part 347 determines whether or not a feature having a name uttered by the user U is present in the visual image A2, and detects the gazed feature when the result of the determination is affirmative. In other words, when the feature having the name uttered by the user U is not present in the visual image A2, the detection part 347 does not detect the gazed feature.

### Detailed Information Acquisition Part 349

The detailed information acquisition part 349 acquires POI information (an example of detailed information) of the gazed feature detected by the detection part 347. Specifically, the detailed information acquisition part 349 acquires POI information corresponding to the gazed feature among the POI information stored in the provision information DB 362.

### Display POI Information

The vehicle display controller 343 displays the POI information acquired by the detailed information acquisition part 349 and the gazed feature in association with each other in the visual image A2. Specifically, the vehicle display controller 343 superimposes and displays the POI information on the gazed feature on the visual image A2. The displayed POI information may be audibly output by the second device 200 (second speaker 240).

The POI information is displayed in a pop-up manner (two dimensionally) in the vicinity of the gazed feature in the visual image A2. The pop-up display is not displayed so as to overlap all of the visual image A2, but is displayed in a small size around the gazed feature. Therefore, all of the POI information may not be contained in the display area of the pop-up display. In this case, the user U may be allowed to scroll the POI information, and all the POI information may be browsed in response to the scrolling. The POI information is not limited to a still image, and may be displayed as a video. The POI information may be displayed as a video only when all the POI information is not contained in the pop-up display.

The POI information is not limited to the two dimensional display, and may be three dimensional display. In the three dimensional display, for example, different information may be displayed on a plurality of pages like a book, and information on other pages may be displayed by receiving an operation of turning pages from the user U. In the three dimensional display, a polyhedron (for example, a dice) with different information displayed on each face may be displayed, and information on other surfaces may be displayed by receiving a selection operation of a display surface from the user U.

### Deletion of POI Information

The vehicle display controller 343 deletes the displayed POI information when a predetermined delete condition is satisfied. The delete condition is satisfied, for example, when the gazed feature is out of the gaze for a predetermined time (for example, 3 seconds) or when the gazed feature is not included in (disappears from) the visual image A2 due to the driving of the mobile vehicle M. Instead of or in addition to the above condition, the delete condition may be satisfied when a delete instruction is input by the HMI 260 from the user U. Thus, the POI information can be deleted based on the operation of the user U. In particular, when the user U is looking only at the front, the POI information of the front feature is continuously displayed, and this information is unnecessary for the user U who wants to look at the front view dimly. In such a case, the POI information can be deleted based on the intention of the user U.

### Content of POI Information

The display content of the POI information is an item of the POI information stored in the provided information DB 362. That is, the display contents of the POI information are the name of the feature, the evaluation, the online reviews, the basic information (address, contact details, opening hours, usage fee), and the like. In a store (for example, a gas station) that provides a commodity whose price changes according to the date and time, the POI information may include the price (unit price) of the commodity, an average value within a predetermined period, a transition of the price, and the like. The POI information of the supermarket that offers bargain products may include details about the bargain product and the price of the bargain product.

### When a Plurality of Features Overlap

It is assumed that a plurality of features are present in an overlapping manner at the point of where the user U focuses on. In this case, the vehicle display controller 343 may display a candidate of the POI information for the overlapping plurality of features. For example, suppose that there is a park in the foreground, a tall building in the background, and Mt. Fuji, which is taller than the building, in the far background. In this case, the vehicle display controller 343 causes the vehicle image display device 250 to display the candidate of the POI information and a pointer (selection button) for selecting the candidate at a position corresponding to the height of each feature. The user U can select one of the candidates by performing a selection operation of the pointer displayed on the vehicle image display device 250. For example, the user U can select a feature (Mt. Fuji) that is present in the background. Thus, even when a plurality of features are present in an overlapping manner, the vehicle display controller 343 can display the POI information of any of the features.

When a plurality of features are present in an overlapping manner, the vehicle display controller 343 may display the POI information of the closest feature or the most popular feature among the overlapping features. The most popular feature may be, for example, a feature that is most frequently detected as the gazed feature based on historical data.

### Maximum Limit of POI Information to be Displayed

The vehicle display controller 343 may set a maximum limit (for example, two) of the number of POI information items to be displayed in the visual image A2, and display the POI information items within the m maximum limit. For example, there is a case where a gazed feature due to the user U gazing at it, a gazed feature due to the user U uttering its name, and a gazed feature due to the user U indicating it with fingertip are detected at the same time. In such a case, a priority order may be set in advance as to which of the gazed features is to be displayed with priority. This can prevent the display area of the visual image A2 from being narrowed by simultaneously displaying a large number of pieces of POI information in the visual image A2.

It is assumed that the POI information is displayed under the condition that the gazing time is set to a predetermined time (for example, 3 seconds) and the delete condition is set to the same time (3 seconds). In this case, even if the POI information of a certain feature (e.g., a building) is displayed due to the user U gazing at the certain feature, the POI information of the building is deleted due to the user U gazing at another feature (e.g., a park) for a predetermined time (due to the building being out of the gaze for a predetermined time). In this way, by setting the predetermined time relating to the POI information display condition and the predetermined time relating to the POI information delete condition to the same time, it is possible to suppress the detection of a plurality of gazed features based on the gaze of the user U. That is, it is possible to suppress the display of a plurality of POI information based on the gaze of the user U for a plurality of gazed features.

### Another Example of Action Information: Pulse

The action information may include information on the pulse of the user U, from the viewpoint that the pulse increases when the user U is excited (when the user U is excited by seeing the gazed feature). The sensor for detecting the pulse may be provided in the second device 200, or may be provided as another device connectable to the second device 200, such as a wearable terminal. In this case, the detection part 347 may detect the gazed feature based on the pulse. Specifically, when the pulse rate is equal to or greater than the threshold value, the detection part 347 may detect, for example, the most popular feature in the visual image A2 as the gazed feature. Thus, when the user U viewing the visual image A2 is excited, in other words, when a feature of interest to the user U is displayed in the visual image A2, POI information can be displayed for the feature.

The detection part 347 may detect the gazed feature based on both the pulse and the action motion information. For example, when there is a feature to which the gaze is directed for a predetermined time (for example, three seconds) or longer and the pulse is equal to or greater than a threshold value, the detection part 347 may detect the feature as the gazed feature. This makes it possible to detect the feature of interest to the user U with higher accuracy.

### Switching On/Off the Display of POI Information

Further, the user U may switch (set) the display of the POI information between on and off. The switching may be performed before the simulated riding or during the simulated riding. Thus, in the case of the user U for whom the POI information is unnecessary, the POI information can be prevented from being displayed.

### About Post Facto View

The management server 300 may store the POI information displayed in the simulated riding. Other device that can access the second device 200 and the management server 300 may be allowed to view the POI information later. Further, during the display of the POI information, a check (selection) may be received from the user U on the spot, and only the checked information may be viewed after the fact. By making it possible to view them after the fact, the user U can view the feature that the user U wants to visit or wants to review again in the simulated riding.

### In Bad Weather

In bad weather, tall features (mountains and towers) that should be visible in the far distance may not be visible. In this case, the vehicle display controller 343 may display the feature on the visual image A2 and POI information corresponding to the feature.

### Fees for Use of POI Information

The fee management part 335 may charge for the service relating to the presentation of the POI information and perform processing relating to the settlement. The service may be provided at a fee according to the number of POI information items displayed or at a flat fee. The payer of the fee is the user U, or may include the passenger P instead of or in addition to the user U.

### Processing Regarding Simulated Riding

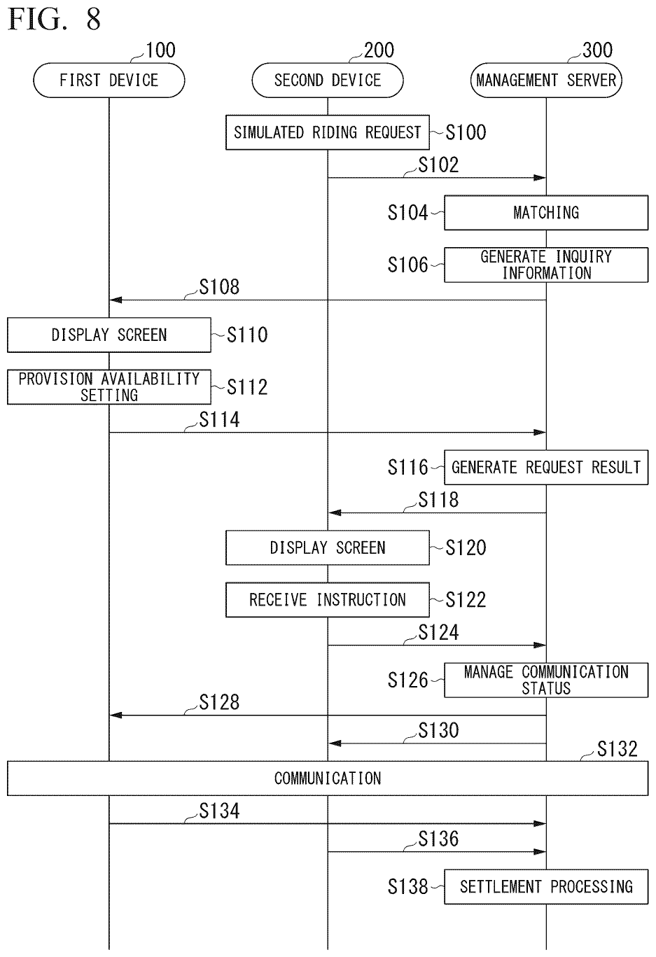

Next, a series of processing executed by the information processing system 1 in the case where the user U is simulated to ride the mobile vehicle M (the passenger P causes the user U to take a simulated riding) will be described in detail. FIG. 8 is a sequence diagram showing an example of processing executed by the information processing system 1. In the example of FIG. 8, the processing in the first device 100 mounted on the mobile vehicle M with the passenger P on board, the second device 200 used by the user U, and the management server 300 is shown. It is assumed that the user U and the passenger P are registered in the management server 300 in advance and registered in the user data 360 in order to receive the provision of the service in the information processing system 1.

In the example of FIG. 8, the second device 200 generates a request for a simulated riding (simulated riding request) (step S100), and transmits the generated simulated riding request to the management server 300 (step S102). The simulated riding request may include information specifying the passenger P in advance, or information specifying the current position or destination of the mobile vehicle M during travel, or the surrounding situation. More specific examples of the simulated riding request include a request such as “wishing to simulated ride in the vehicle driven by Mr. A” or “wishing to simulated ride in the vehicle traveling on a road within the city”. These are examples of the matching requests described above.

The matching processing part 320 of the management server 300 receives the simulated riding experience request from the second device 200 and performs matching processing based on the user data 360 (step S104). When there is at least one matching mobile vehicle M, the provision part 330 generates inquiry information for inquiring whether or not to allow the simulated riding to all the mobile vehicle M (step S106), and transmits the generated information to the first device 100 of the matching mobile vehicle M (step S108).

The first device 100 displays the setting screen that includes the inquiry information transmitted from the management server 300 (step S110). The setting screen includes buttons for selecting information about the user U who has made the simulated riding request or information provided to the user U by the passenger P (whether or not a call is made, whether or not an indoor image is displayed, and the like), and buttons indicating whether or not the user U can be allowed to perform the simulated riding.

The first device 100 accepts the provision availability setting of the user U from the setting screen (step S112) and transmits the accepted provision availability setting information to the management server 300 (step S114). The providing part 330 of the management server 300 generates a request result (response result) based on the provision availability setting information obtained from the first device 100 (step S116) and transmits information indicating the generated request result to the second device 200 (step S118).

The second device 200 receives the request result from the management server 300 and displays information indicating the received request result on the result screen (step S120). The result screen includes information on the passenger P who has permitted the simulated riding request, a list of information permitted by the passenger P, a fee (service usage fee) based on the permitted information, a switch for selecting whether or not to accept the simulated riding, and the like.

The second device 200 receives a selection instruction from the user U on the result screen (step S122) and transmits the received instruction information to the management server 300 (step S124). In the following description, it is assumed that the user U has given an instruction to simulated ride in the mobile vehicle M of the passenger P. The management server 300 manages the communication status between the first device 100 and the second device 200 based on the instruction from the second device 200 (step S126) and transmits information indicating that the simulated riding is to be executed to the first device 100 and the second device 200 (steps S128 and S130). When the user U selects not to take the simulated riding in the processing of steps S126 to S130, the providing part 330 of the management server 300 transmits information indicating the selection to the first device 100 and notifies the user U.

Next, the first device 100 and the second device 200 execute the simulated riding through the management server 300 or by directly communicating with each other (step S132), and when the simulated riding is completed, the first device 100 and the second device 200 transmit information indicating that the communication is completed to the management server 300 (steps S134, S136). In the processing of step S132, the second device 200 may send a notification from the user U to the passenger P before the information from the first device 100 is provided to the second device 200. Thus, the user U can permit the communication at his own timing and start the information provision such as the telephone conversation and the video distribution. Next, the fee management part 335 of the management server 300 performs a settlement processing for the use of the service of each of the first device 100 and the second device 200. Specifically, the fee management part 335 varies the fee for information provision based on at least one of the types of the passenger P, the user U, and the mobile vehicle M that provide information, the type of information that can be provided to the user U, and the amount of information. For example, when the passenger P or the user U is a celebrity, the usage fee is set higher than the normal fee. The usage fee may be set higher than the normal fee when the mobile vehicle M is a new car or a rare car. The fee management part 335 performs a settlement processing corresponding to the set fee. Then, the processing of this sequence completes.

### Display Control Processing Performed by Management Server 300 in Simulated Riding

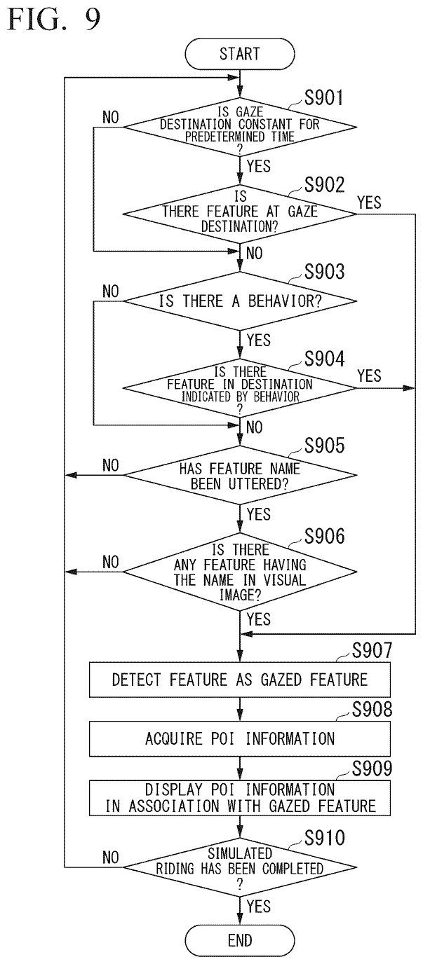

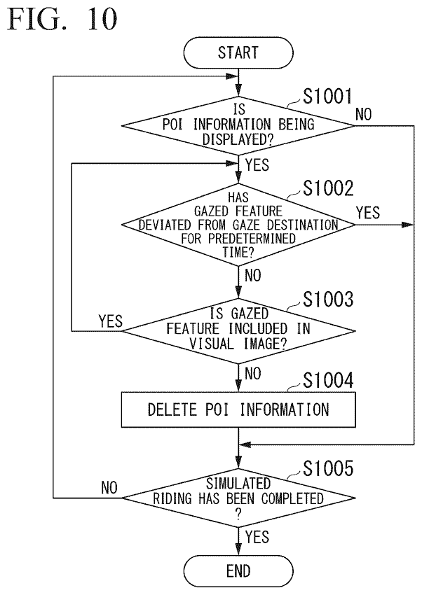

Next, the display control processing performed by the management server 300 in the execution of the simulated riding (step S132 in FIG. 8) will be described with reference to FIGS. 9 and 10. The processing shown in FIGS. 9 and 10 is executed in the control cycle of the management server 300 during execution of the simulated riding.

### Display Processing of POI Information

FIG. 9 is a flowchart showing an example of a display processing of POI information performed by the management server 300. In FIG. 9, the management server 300 determines whether the gaze destination obtained from the gaze information on the visual image A2 is constant for a predetermined time (for example, 3 seconds) (step S901). If the gaze destination is not constant for the predetermined time (step 901: NO), the management server 300 proceeds to the process of step S903. On the other hand, if the gaze destination is constant for the predetermined time (step S901: YES), the management server 300 determines whether or not there is a feature at the gaze destination on the visual image A2 (step S902).

If there is a feature in the gaze destination (step S902: YES), the management server 300 proceeds to the process of step S907 and detects the feature as the gazed feature. On the other hand, when there is no feature in the gaze destination (step S902: NO), the management server 300 determines whether or not there is a behavior based on the behavior information (step S903). If there is no behavior (step S903: NO), the management server 300 proceeds to the process of step S905. On the other hand, if there is a behavior (change in the direction of the fingertip or the face) (step S903: YES), the management server 300 determines whether or not there is a feature in the destination indicated by the behavior (step S904).

If there is a feature in the destination indicated by the behavior (step S904: YES), the management server 300 proceeds to the processing of step S907 and detects the feature as the gazed feature. On the other hand, if there is no feature in the destination indicated by the behavior (step S904: NO), the management server 300 determines whether or not the user U has uttered a feature name based on the audio information (step S905). If the user U does not utter the feature name (step S905: NO), the management server 300 returns to the process of step S901.

On the other hand, if the user U has uttered the feature name (step S905: YES), the management server 300 determines whether or not a feature having a name uttered by the user U is present in the visual image A2 (step S906). If the feature having the name uttered by the user U does not present in the visual image A2 (step S906: NO), the management server 300 returns to the process of step S901. On the other hand, if the feature having the name uttered by the user U is present in the visual image A2 (step S906: YES), the management server 300 detects the feature as the gazed feature (step S907).

Then, the management server 300 acquires POI information corresponding to the gazed feature from the POI information stored in the provision information DB 362 (step S908), and displays the acquired POI information on the second device 200 (the vehicle image display device 250) in association with the gazed feature (step S909). Next, the management server 300 determines whether or not the execution of the simulated riding has been completed (step S910). If the execution of the simulated riding is not completed (step S910: NO), the management server 300 returns to the process of step S901. On the other hand, if the execution of the simulated riding is completed (step S910: YES), the management server 300 ends the series of processing shown in FIG. 9.

### Deleting Processing of POI Information

FIG. 10 is a flowchart showing an example of a delete processing of POI information performed by the management server 300. In FIG. 10, the management server 300 determines whether or not the POI information is being displayed in the second device 200 (step S1001). If the POI information is not being displayed (step S1001: NO), the management server 300 proceeds to the process of step S1005. On the other hand, if the POI information is being displayed (step S1001: YES), the management server 300 determines whether or not the user's gaze has deviated from the gazed feature for a predetermined time (step S1002).

If the gaze destination deviates from the gazed feature for the predetermined time (step S1002: YES), the management server 300 proceeds to step S1004 and deletes the POI information. On the other hand, if the gazed feature is not deviated from the gaze destination for the predetermined time (step S1002: NO), the management server 300 determines whether or not the gazed feature is included in the visual image A2 (step S1003). If the gazed feature is included in the visual image A2 (step S1003: YES), the management server 300 returns to step S1002 and repeats the processing of steps S1002 and S1003.

On the other hand, if the gazed feature is no longer included in the visual image A2 (step S1003: NO), the management server 300 deletes the POI information (step S1004). Then, the management server 300 determines whether or not the execution of the simulated riding has been completed (step S1005). If the execution of the simulated riding is not completed (step S1005: NO), the management server 300 returns to the process of step S1001. On the other hand, if the execution of the simulated riding is completed (step S1005: YES), the management server 300 ends the series of processing shown in FIG. 10.

### Information Provided During Simulated Riding

Next, the information provided to the user U during the simulated riding will be described by dividing it into several examples. The following examples are information provided in the processing of step S132 shown in FIG. 8, and the output mode of information provided to the second device 200 differs depending on, for example, an operation by the user U and the type or amount of information that can be provided to the user U. In the following example, it is assumed that the provision of the indoor image, the outdoor image, and the communication (call) is permitted by the passenger P.

### Example of POI Information Based on Gaze Information

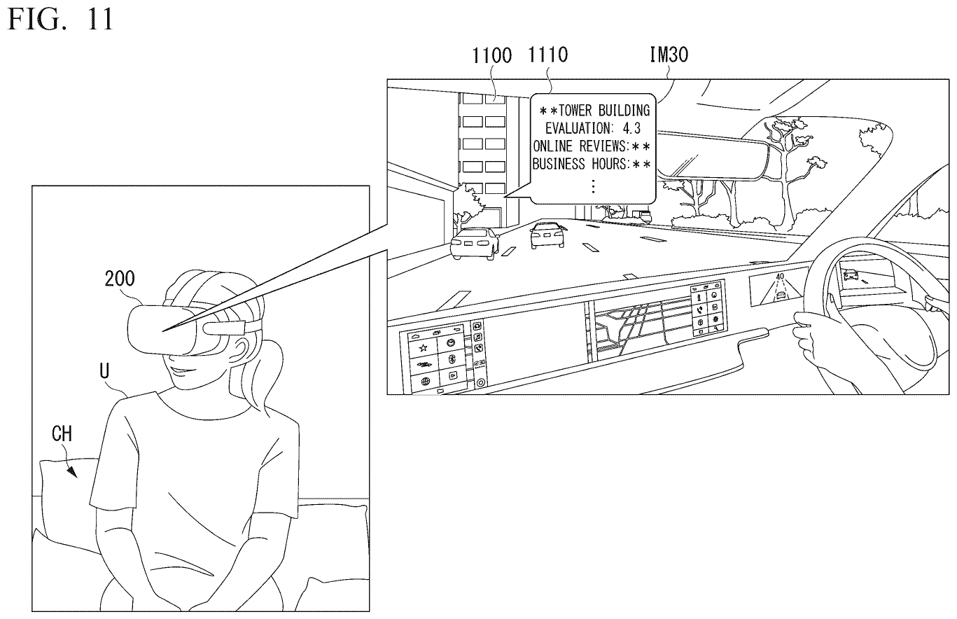

FIG. 11 is a diagram showing a display example of POI information based on gaze information. In the example of FIG. 11, an example of the user U seated on the chair CH at a different place from the mobile vehicle M (for example, a room of the user's home) and an example of the indoor image IM30 provided from the second device 200 (for example, the VR goggles integrated type in FIG. 11) used by the user U are shown. The state of the user U (sitting on the chair CH) shown in the example of FIG. 11 indicates an initial state immediately after the execution of the simulated riding, and the first device 100 and the second device 200 recognize the position (reference posture) of the user U at this time as a reference position. The reference position is a position assumed that the user U is seated on the passenger seat S2. The reference position may be corrected so that the height of the indoor camera 132 matches the sitting height of the user U by the first control device 170 driving the seat drive device based on the physique information such as the height or sitting height information of the user U registered in the user information of the user data 360 (so-called zero point correction). The reference position may be corrected by a correction instruction from the user U who has viewed the indoor image IM30. The reference position may include orientation information when the user U is seated on the chair CH and faces forward.

For example, in a state where the user U is seated on the chair CH and faces an arbitrary direction from the reference position of the user U (the second device 200), an image captured by the indoor camera 132 of the first device 100 according to the direction is provided as the indoor image IM30. Thus, the user U can acquire an indoor image in an arbitrary direction as viewed from the passenger seat S2. Further, audio information such as the voice of the passenger P and the sound of the interior and exterior of the mobile vehicle M, which is acquired by the first microphone 120, is provided to the user U. The user U can enjoy conversation as if he/she is actually riding the mobile vehicle M by conversing with the passenger P using the interior image IM30 and the audio information.

In the figure, it is assumed that the user U is gazing at the building 1100 reflected in front. When the gaze destination is directed to the building 1100 for a predetermined time, the POI information 1110 is superimposed on the indoor image IM30. The POI information 1110 includes various information such as the name, evaluation, online reviews, opening hours, age of the building, floor, and management company of the building 1100. Thus, the user U can understand detailed information about the building 1100.

### Example of POI Information Based on Behavior Information

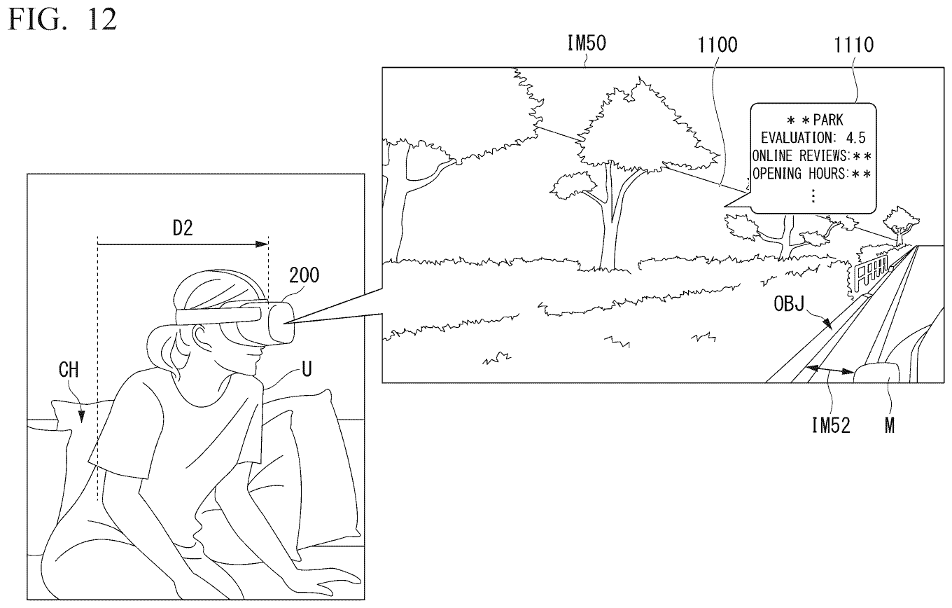

FIG. 12 is a diagram showing a display example of POI information based on behavior information. FIG. 12 shows an example in which an outdoor image on the side of the mobile vehicle M is provided instead of an indoor image, as compared with the example of FIG. 11.

In the example of FIG. 12, the outdoor image IM50 provided when the direction of the face of the user U (the second device 200) is moved by the distance D2 in the lateral direction from the reference position is shown. In this case, the first device 100 determines whether the moved distance D2 is equal to or greater than a threshold value, and if the moved distance D2 is equal to or greater than the threshold value, the first device 100 switches the display from the indoor image IM30 by the indoor camera 132 to the outdoor image IM50 by the outdoor camera 134. In the example of FIG. 12, since the distance D2 is equal to or greater than the threshold value, the outdoor image IM50 (more specifically, the image of the front side because the user is slightly directed forward) captured from the side of the mobile vehicle M in the moving direction is displayed. Thus, the user U can obtain an experience peculiar to the simulated riding, as if the user U is looking at the surrounding scenery with his/her head out from the side of the mobile vehicle M (e.g., a side window). The threshold value may be a fixed value or may be variably set in accordance with the vehicle class information of the mobile vehicle M.

In the figure, it is assumed that the user U faces the park 1200 reflected on the side. When the face is directed to the park 1200, the POI information 1210 is superimposed on the outdoor image IM50. The POI information 1110 includes various information such as the name, evaluation, online reviews, opening hours, and usage fee of the park 1200. Thus, the user U can understand detailed information about the park 1200.

The image including the POI information may be provided to the first device 100. This enables the passenger P to more accurately understand what kind of image the user U is currently viewing, and to perform more appropriate conversation.

In the embodiment, the first device 100 may generate an image as if the user U is seated in the passenger seat S2 (or the rear seat), and display the generated image on the rearview mirror display device or the window. In this case, the first control device 170 generates a person image in which the user U or a character corresponding to the user U is seated on the passenger seat S2, and displays the generated image on the rearview mirror display device. In this case, the posture of the person image may be changed according to the motion of the user U obtained from the second device 200. The first control device 170 may control the first speaker 140 so as to output an audio from the vicinity of the passenger seat S2 when a person image is displayed on the rearview mirror display device 152. This audio is, for example, a voice that the user U has uttered to the second microphone 220, and is transmitted by the second communication device 210 and acquired via the first communication device 110. The first control device 170 causes the first speaker 140 to output an audio whose audio image (sound image) is localized so that the passenger P in the driver's seat can hear the audio from the passenger seat S2, for example.

### Modification

In the information processing system 1 described above, at least a part of the functions of the first device 100 and the second device 200 may be provided in the management server 300, and at least a part of the functions of the management server 300 may be provided in the first device 100 or the second device 200.

For example, the respective functional parts of the vehicle display controller 343, the action information acquisition part 345, the detection part 347, and the detailed information acquisition part 349 may be provided in the second device 200. The configuration of the second device 200 including the functional parts will be described below. A vehicle display controller 343 provided in the second device 200 acquires a captured image from a camera unit 130 provided in the first device 100 and displays a visual image A2 on a vehicle image display device 250 on the basis of the captured image. The action information acquisition part 345 acquires action information from the oriented direction detection device 232, the motion sensor 236, and the second microphone 220. The detection part 347 detects the gazed feature in the visual image A2 based on the action information. The detailed information acquisition part 349 acquires POI information of the gazed feature by making an inquiry to the management server 300. The vehicle display controller 343 displays the gazed feature and the POI information in association with each other. As described above, the second device 200 having the respective functional parts can also cause the vehicle image display device 250 to display the POI information of the gazed feature.

The management server 300 may have the function of the image editing part 276. That is, the management server 300 may have all functions relating to image editing and image display control.

### Summary

According to the information processing system 1 configured as described above, the gazed feature in the visual image A2 is detected based on the action information, and the POI information of the detected gazed feature and the gazed feature are displayed in association with each other on the second communication device 210.

Thus, POI information of a gazed feature of interest to the user U in the simulated riding can be provided to the user U.

### REFERENCE SIGNS LIST

1 Information processing system
100 First device
110 First communication device
120 First microphone
125 External sensor
130 Camera unit (Imaging part)
132 Indoor Camera
134 Outdoor Camera
140 First speaker
150 User display device
160 HMI
170 First control device
190 Control target equipment
200 Second device
210 Second communication device
220 Second microphone
230 Detection device
232 Oriented direction detection device
236 Motion sensor
240 Second speaker
250 Vehicle image display device
260 HMI
270 Second control device
300 Management Server
310 Communication device
315 Acquisition part
320 Matching processing part
330 Provision part
335 Fee management part
343 Vehicle display controller (Display control part)
345 Action information acquisition part (Body movement information acquisition part)
347 Detection part
349 Detailed information acquisition part
350 Storage part
P Passenger
M Mobile vehicle (Mobile object)
U User

What is claimed is:

1. An information management device that manages information provided to a first device mounted on a mobile object in or on which a passenger rides and a second device used by a user at a different place from the mobile object, the information management device comprising:
a display control part configured to cause the second device to display an image based on a captured image captured by an imaging part provided by the first device;
a body movement information acquisition part configured to acquire body movement information indicating a body movement of the user;
a detection part configured to detect a feature in the image that the user focuses on based on the body movement information acquired by the body movement information acquisition part; and
a detailed information acquisition part configured to acquire detailed information of the feature detected by the detection part;
wherein the display control part displays the feature and the detailed information in association with each other.

2. The information management device according to claim 1, wherein the body movement information includes gaze information indicating a gaze destination of the user, and
wherein the detection part detects the feature at the gaze destination for a predetermined time or longer based on the gaze information.

3. The information management device according to claim 1, wherein the body movement information includes behavior information indicating a behavior of the user, and
wherein the detection part detects the feature indicated by the behavior based on the behavior information.

4. The information management device according to claim 2, wherein the body movement information includes behavior information indicating a behavior of the user, and
wherein the detection part detects the feature indicated by the behavior based on the behavior information.

5. The information management device according to claim 1, wherein the body movement information includes audio information indicating a voice uttered by the user, and
wherein the detection part detects the feature having the name uttered by the user based on the audio information.

6. The information management device according to claim 2, wherein the body movement information includes audio information indicating a voice uttered by the user, and
wherein the detection part detects the feature having the name uttered by the user based on the audio information.

7. A display control method that is performed by a computer of an information management device that manages information provided to a first device mounted on a mobile object in or on which a passenger rides and a second device used by a user at a different place from the mobile object, the display control method comprising:
a first display control step of causing the second device to display an image based on a captured image captured by an imaging part provided by the first device;
a body movement information acquisition step of acquiring body movement information indicating a body movement of the user;
a detection step of detecting a feature in the image that the user focuses on based on the body movement information acquired in the body movement information acquisition step;
a detailed information acquisition step of acquiring detailed information of the feature detected in the detection step; and
a second display control step of displaying the feature and the detailed information in association with each other.

8. A program causing a computer of an information management device that manages information provided to a first device mounted on a mobile object in or on which a passenger rides and a second device used by a user at a different place from the mobile object, the computer to perform:
causing the second device to display an image based on a captured image captured by an imaging part provided by the first device;
acquiring body movement information indicating a body movement of the user;
detecting a feature in the image that the user focuses on based on the body movement information acquired by a body movement information acquisition part;
acquiring detailed information of the feature detected by a detection part; and
displaying the feature and the detailed information in association with each other.
